(19) United States
(12) Patent Application Publication
(10) Pub. No.: US 2012/0235811 A1
(43) Pub. Date: Sep. 20, 2012

(54) Independent Brake and Vinker Lights System for Vehicle

(76) Inventor: YEHOSHUA RAHAMIM LEVI, Ramat Gan (IL)

(21) Appl. No.: 13/487,204

(22) Filed: Jun. 3, 2012

(30) Foreign Application Priority Data
Dec. 8, 2009 (IL) 202589
Dec. 6, 2010 (IL) PCT/IL2010/001028

(51) Int. Cl. B60Q 1/34; B60Q 1/44

(52) U.S. Cl. 340/475

(57) ABSTRACT

The system, subject of this invention, designed to issue a warning upon braking or turning on the Vinker lights of a motorcycle that includes sensors that detects when the motorcycle's brakes and vinker lights are working, a control unit including a processor and an illumination panel that can be attached to the motorcycle driver's helmet or clothing.

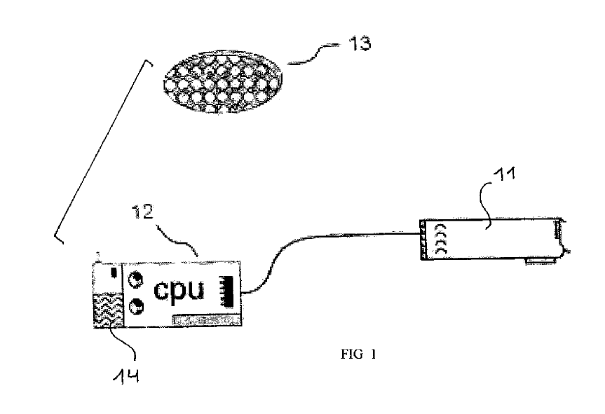

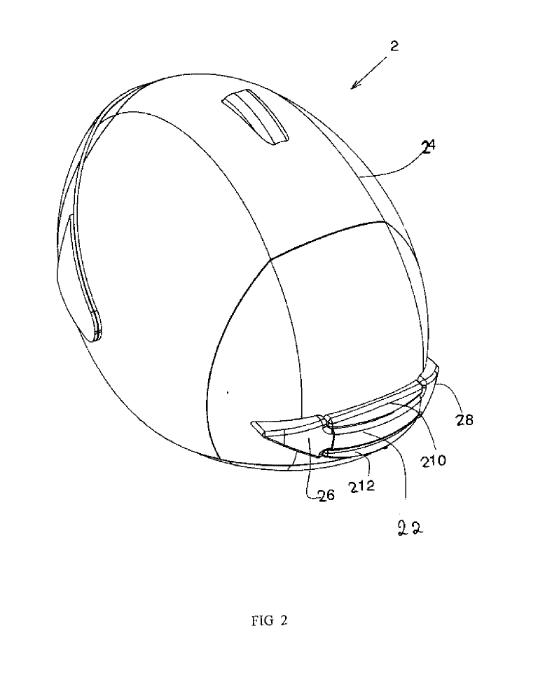

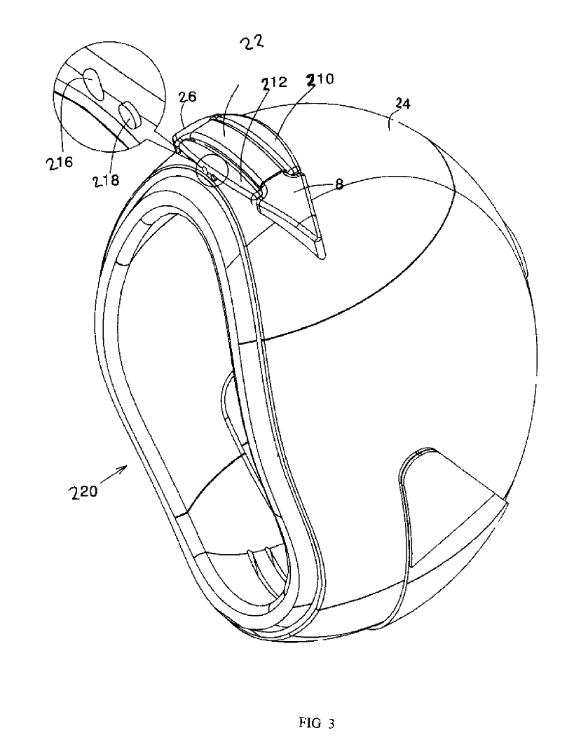

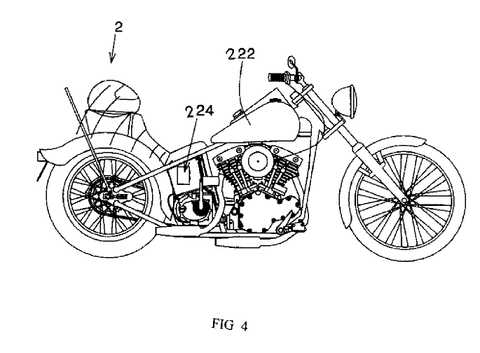

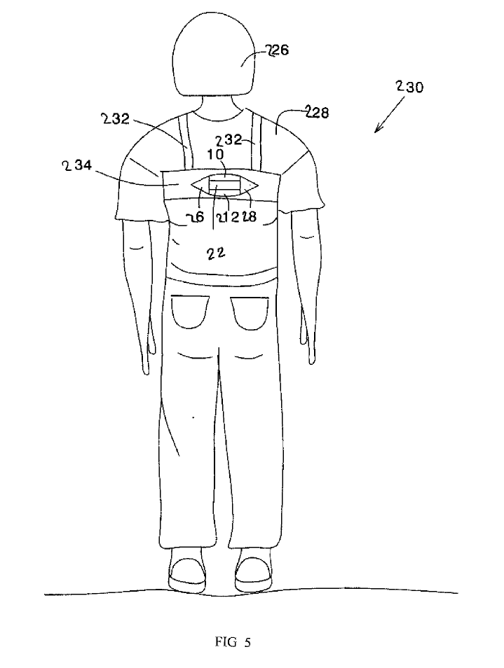

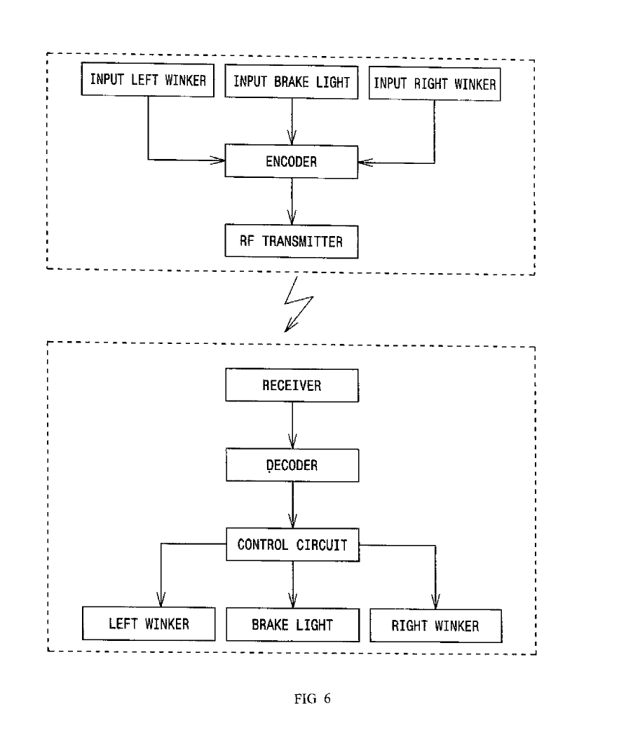

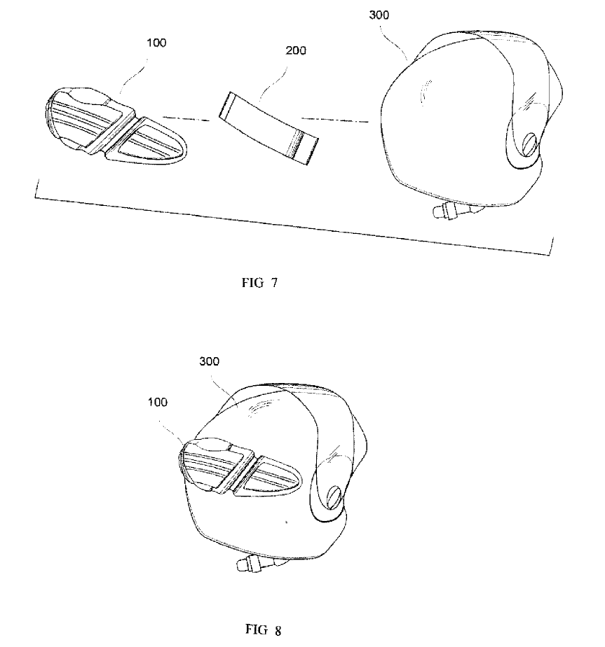

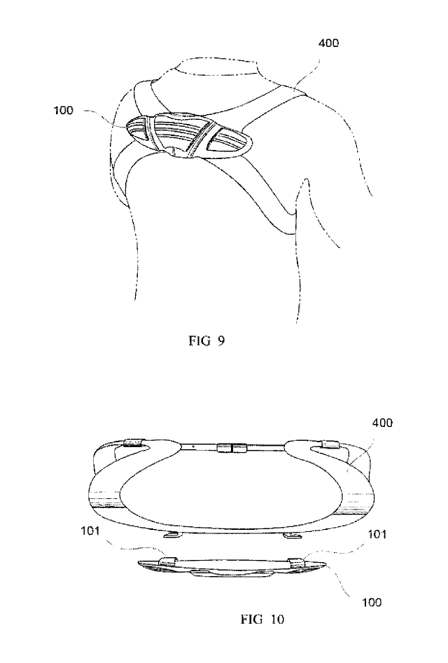

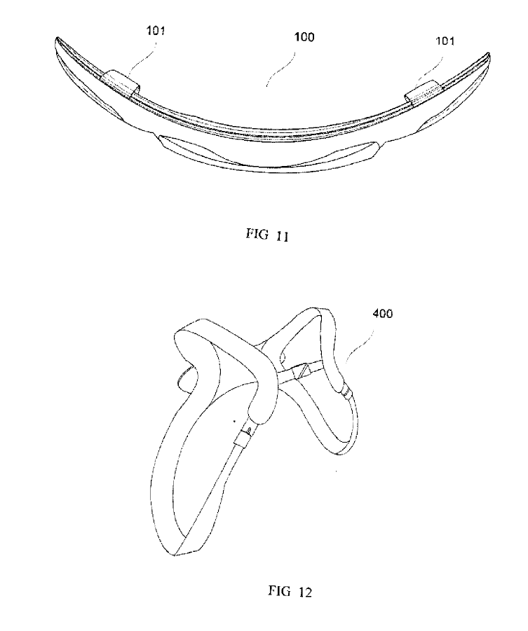

### TECHNICAL FIELD

The systems, subject of the present invention, pertain to the field of motor vehicles.

### BACKGROUND ART

The system, subject of the present invention, is designed to alert drivers in any case that a motorcycle or motorbike (hereinafter the word “motorcycle” means also motorbike and other two-wheel vehicles) driver brakes his vehicle.

### THE DRAWINGS

Drawing 1 depicts the schematic drawing of the System (1).

Drawings 2 and 3 depict the helmet (2) and its components.

Drawing 4 depicts the helmet (2) on a motorcycle.

Drawing 5 depicts the system (1) attached to a driver.

Drawing 6 depicts a flow card of the System (1).

Drawings 7 and 8 depict a wireless portable illumination panel (100) aimed to be affixed to a regular helmet (300) by means of a carrier (200).

Drawing 9 depicts the illumination panel (100).

Drawing 10 depicts the harness (400).

Drawing 11 depicts the panel (100) and the harness (400) attached to the driver shoulders.

Drawing 12 depicts the panel (100) and the harness (400).

### THE INVENTION

The system (1) is designed to issue a warning when a motorcycle breaks or intend to turn.

The first embodiment of the invention refers to the system (1) that designed to be installed on a motorcycle, and includes a device (11) that detects the application of the motorcycle brakes and Vinker lights; a control unit (12) including a CPU that receives the information that the brakes or the Vinker lights have been engaged; and an illumination panel (13) that can be attached to the driver's helmet or his clothes. The illumination panel (13) includes an independent power source (i.e. a battery) and a receiver designed to receive the signal from the control unit (12). The system also includes a transmitter (14), attached to the control unit, that transmits the signal to the receiver located on the illumination panel (13). The signal can, of course, be relayed to the illumination panel also by means of a wire connection. Drawing No. 1 is a schematic drawing of the System (1).

When the driver of the motorcycle or motorbike steps on the brakes or turn-on the Vinker lights, the processor in the control unit (12) transmits a signal to the receiver on the illumination panel (13), thereby activating the illumination panel attached to the back of the driver's helmet or to any other conspicuous place, thus warning the drivers in vehicles behind him that the motorcycle ahead is decelerating or intends to turn. The moment the motorcycle driver releases pressure from the brake pedal or turn-of the Vinker lights, the signal stops and the illumination panel (13) goes off.

The objective of the System (1) is to enable drivers on the road to clearly recognize when a motorcycle driver is braking or intend to turn. The problem is that, at present, braking lights and Vinkers lights on motorcycles are located relatively low and are inconspicuous, whereas the illumination panel (13) of the system (1), which is attached to the back of the motorcycle driver's helmet or cloths, is very conspicuous.

In the second embodiment of the present invention the illumination panel (13) can be permanently fixed or can be an integral part of the helmet itself. The illumination panel (13) can include an indicator or lamp that illuminates when the turn signals are on. The illumination panel (13) can include two indicators or lamps that, in fact, parallel the operation of the motorcycle regular turn signal lights, so that the right- or left-hand indicator on the illumination panel lights up when signalling a right- or left-hand turn, respectively. The control unit (12) will include a device that provides data on the operation of the motorcycle turn signal lights. Alternatively, the illumination panel (13) can be separate and be attached to the helmet or the motorcycle delivery box, or to the clothes of the driver or passenger riding behind the driver, or to any other location. The connection between the illumination panel (13) and the main part of the System (1) can be either wireless or wired (including connection to the vehicle's regular source of power).

The illumination panel (13) can be fixed or an integral part of the helmet itself and will include indicator lights that parallel the motorcycle's turn signal lights. The system's electrical connection can be directly to the vehicle's electrical system or battery by means of two clips (so-called “bananas”) or a fast connection socket/plug, which will be built-in in the vehicle. The system will enable to connect the battery on the helmet with the motorbike's battery, including a charging option. The system will include a receive, on the helmet, that will receive a signal when the motorbike's turn signal lights are on and will activate the parallel indicator lights on the helmet's illumination panel (13). The system (1) will include a sensor that will detect the activation of brake lights by the vehicle traveling in front of the motorbike and will activate the brake indicator lights on the helmet's illumination panel. It is hereby clarified that the system's illumination panel can be affixed to the helmet, to the clothes of the driver or the passenger seated behind the driver, the delivery box or any other part of the motorbike.

The third embodiment of the present invention refers to a Helmet (2) with turn indicator and brake lights (22) which includes the following components: helmet (24); left-hand indicator light (26); right-hand indicator light (28); wireless receiver (210); battery (212); brake light (214); charging socket (216); On/Off pushbutton (218); helmet interior (220); unit that attaches to vehicle's turn indicator and brake lights and transmits signal to motorcycle helmet (224); regular helmet (226); shoulder straps to support said belt (232); belt with illumination device for indicator and brake lights (234). The following Drawings indicate also a two-wheeled vehicle (222), the motorcycle driver (228) and additional method whereby indicator and brake lights are illuminated on a belt device (230). Drawings 2-6 describe the System (1).

The Forth embodiment of the present invention refers to the System (1) as described in Drawings no. 7-12. Drawings No. 7 and 8 depicting a wireless, portable illumination panel (100) that can be affixed to a regular helmet (300) by means of a carrier (200). The carrier is in fact a plate made of metal or plastic or any other rigid material. The carrier (200) can be affixed to the helmet (300) using double-sided sticky tape. Thus, the illumination panel (100) can be affixed to a regular helmet (300) by attaching it to the carrier, with no need for complex and complicated adjustments. Drawing No. 9 is depicting the illumination panel (100). The upper interior part of the illumination panel includes two clips (101) that enable its attachment to the carrier (200). Drawing No. 10 is depicting a harness (400) that the driver (or passenger seated behind) can wear on his or her shoulders as depicted in Drawing No. 11. The illumination panel (100) can be affixed to the harness (400) using the two clips (101), as depicted for instance in Drawings Nos. 11 and 12.

The system of the Forth embodiment includes a sensor that can either be built into the motorcycle or attached to it. The sensor detects the activation of the turn indicator and brake lights and accordingly transmits a signal to the illumination panel (100) that is attached to the helmet (300). The system may include several sensors intended to detect the separate activation of the vehicle's turn indicator lights and brake lights.

The sensor may be light-based or heat-based or may operate according to any other principle that enables to detect activation of the relevant light. The advantage of a system that is equipped with a sensor as described is, among other things, in that there is no need to involve and/or connect to any of the motorcycle's existing systems. The sensor can be affixed or attached to the plastic that covers the said lights using a sticker or any other means. Another option for the implementation of the invention is using a sensor that is located on the illumination panel (100), which detects the activation or deactivation of the turn indicator and brake lights and, accordingly, sends an activation command to the illumination lights on the illumination panel. Thus, there is no need to involve the motorcycle or any of its parts. The signal may be transmitted on a variety of frequencies. The system may include one or more sensors. It is possible to use a sensor located on the illumination panel, which detects the activation and deactivation of the vehicle's turn indicator and brake lights. This sensor may function by filtering the constant background light (such as sunlight, street lights, and so on).

What is claimed is:

1. A system designed to issue a warning upon braking or turning on the Vinker lights of a motorcycle that includes a device that detects pressure on the motorcycle's brake pedal or turning on the vinker lights; a control unit including a processor; and an illumination panel that can be attached to the motorcycle driver's helmet or clothing.

2. A motorcycle Helmet with panel of lights that integrally affixed to it and which indicates the application of the brake and vinkers lights of the motorcycle which further comprising wireless receiver, battery, unit that attaches to the motorcycle's turn indicator and brake lights that aimed to transmits signal to the Helmet; whereby the said unit transmit a signal to the panel in the helmet whenever that brake and the vinker lights or off or on.

3. A system designed to issue a warning upon braking or turning on the Vinker lights of a motorcycle that includes an illumination panel, one or more sensors, a control unit and a carrier;
Wherein the said illumination panel include two indicators or lamps that parallel the operation of the motorcycle regular turn signal lights, so that the right- or left-hand indicator on the illumination panel lights up when signalling a right- or left-hand turn, respectively; wherein the said illumination panel include an indicator or lamp that parallel the operation of the motorcycle regular brake signal lights, so that it lights up when signalling the brake light work; Wherein the said illumination panel is a separate and be attached to the helmet or the motorcycle delivery box, or to the clothes of the driver or passenger riding behind the driver, or to any other location.
Wherein the said sensors detect the activation of the turn indicator and brake lights and transmit signals to the said illumination panel;
Wherein the said control unit including a processor that provides data on the operation of the motorcycle brake and turn signal lights;
Wherein the said illumination panel and the said sensors are connected by wireless connection;
Wherein the said carrier is made of a rigid material and that can be affixed to the helmet; wherein the said illumination panel can be affixed to a regular helmet by attaching it to the carrier,

4. The system as describes in claim 3 wherein it also includes a harness that the driver (or passenger seated behind) can wear on his shoulders and on which the said illumination panel can be affixed.
